(19) United States
(12) Patent Application Publication
(10) Pub. No.: US 2002/0145230 A1
(43) Pub. Date: Oct. 10, 2002

(54) Injection encapsulating process for a 3D animation cup

(76) Inventor: Hsien-Tsung Yeh, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/828,970

(22) Filed: Apr. 10, 2001

(51) Int. Cl. B29C 45/14

(52) U.S. Cl. 264/250; 264/255; 264/279.1

(57) ABSTRACT

An injection encapsulating process for a 3D-animation cup transfers a 3D-animation layer to an inner cup, followed by transfer of a thermal-withstanding protection layer to exterior of said 3D-animation layer, then both layers transferred to the surface of the inner cup before being placed in dies to be encapsulated and become an integrated with an injection molded transparent outer cup.

### BACKGROUND OF THE INVENTION

(a) Field of the Invention

The present invention relates to an injection encapsulating process for a 3D-animation cup, and more particularly to one that allows the 3D-animation is printed on an inner cup wall and encapsulated with a layer of transparent cup wall by injection.

(b) Description of the Prior Art

Whereas, the cups encapsulated generally available in the market today with pattern on an inner and/or an outer cup wall involves the setting or printing of the pattern on the surface of the inner cup wall, then sprayed with a varnish protection coating. However, varnish is not thermal resisting. As illustrated in FIG. 14 of the accompanying drawings of the present invention, said varnish protection coating (4A) on the inner cup wall (3A) is always rough. Once the varnish protection layer (4A) dries up, the inner cup (3A) (including the pattern and the varnish protection itself) is placed between an upper die (5A) and a lower die (6A) for injection into a molded outer cup (7A). Usually, the injection point for the outer cup is located at the bottom of the cup as illustrated in FIG. 15. Now referring to FIGS. 16 and 17, a plastic flux flows upward in the direction as indicated by the arrow to heat up and flush the varnish protection layer (4A) and the pattern (1A) to melt ink thereon. Whereas plastic is injected at a comparatively high pressure and the pattern is not secured in position, the pattern (1A) can be easily washed off resulted in paste moving from the bottom of the cup upward. As illustrated in FIG. 17, the pattern (1A) is completely vanished. That's why in the market, there are only some pattern, if any, that either shows blur or irregular one, leaving alone any meaningful pattern or animation. Even there does present certain pattern seriously encapsulated, the mass quantity of nonconformity happening in process would frustrate mass production at a lower production cost.

### SUMMARY OF THE INVENTION

The primary purpose of the present invention is to provide a 3D-animation cup encapsulating method. To achieve this purpose, a 3D-animation layer is first transferred to an inner cup, then another thermal withstanding protection layer is transferred to the exterior of said 3D-animation layer. Both layers then further thermally transferred onto the surface of the inner cup, and finally the inner cup is placed in molding dies to form a transparent outer cup encapsulating the inner cup by injection.

### BRIEF DESCRIPTION OF THE DRAWINGS

FIG. 1 is a schematic view showing a process of the present invention (transferring a transferred pattern and a thermal-withstanding layer).

FIG. 2 is a sectional view showing an in-process of the present invention (including an inner cup, a transferred pattern and a thermal-withstanding layer).

FIG. 3 is another schematic view showing the process of the present invention (encapsulating by injection).

FIG. 4 is a schematic view of a finished product of the present invention.

FIG. 5 is a detailed sectional view of the finished product of the present invention.

FIGS. 6 and 7 are schematic views showing a preferred embodiment of the present invention.

FIGS. 8 through 13 are schematic views showing another preferred embodiment of the present invention.

FIG. 14 is a sectional view of an in-process (prior to encapsulating by injection) of the prior art.

FIG. 15 is a schematic view of a preferred embodiment of the encapsulating by injection of the prior art.

FIG. 16 is a blowout view of FIG. 15 (with the arrow indicating the flow direction of plastic flux).

FIG. 17 is a schematic view of a finished product using the preferred embodiment illustrated in FIG. 15.

### DETAILED DESCRIPTION OF THE PREFERRED EMBODIMENTS

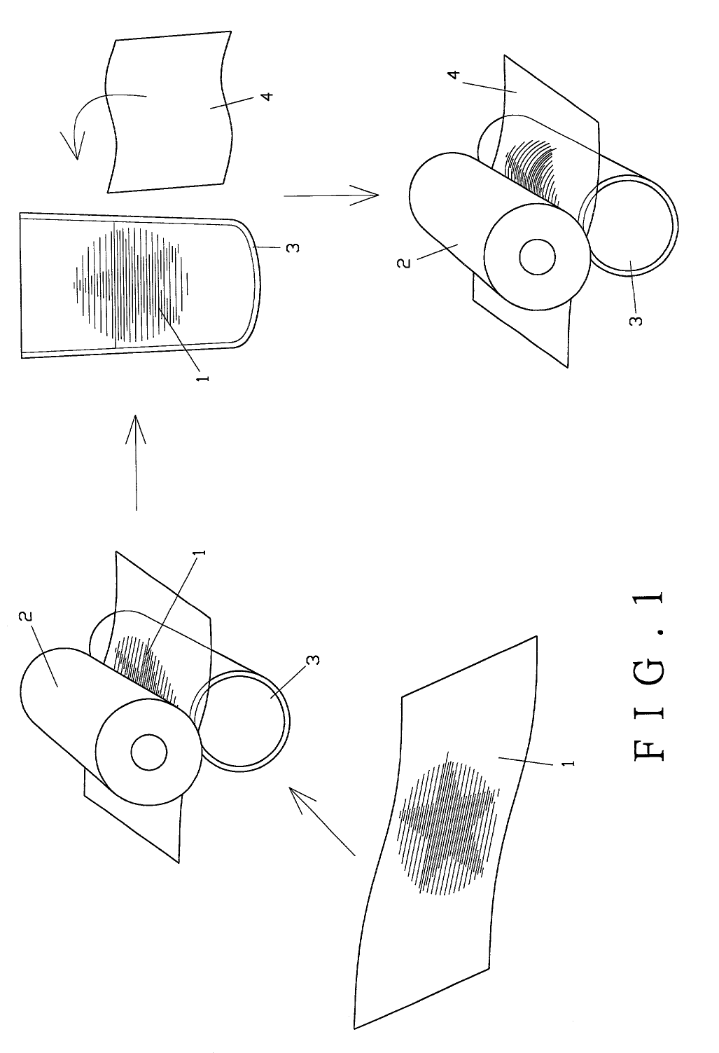

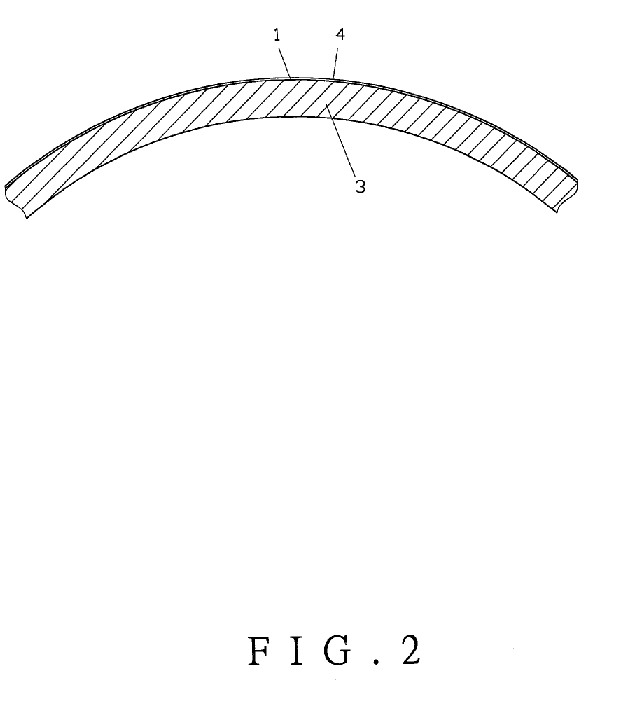

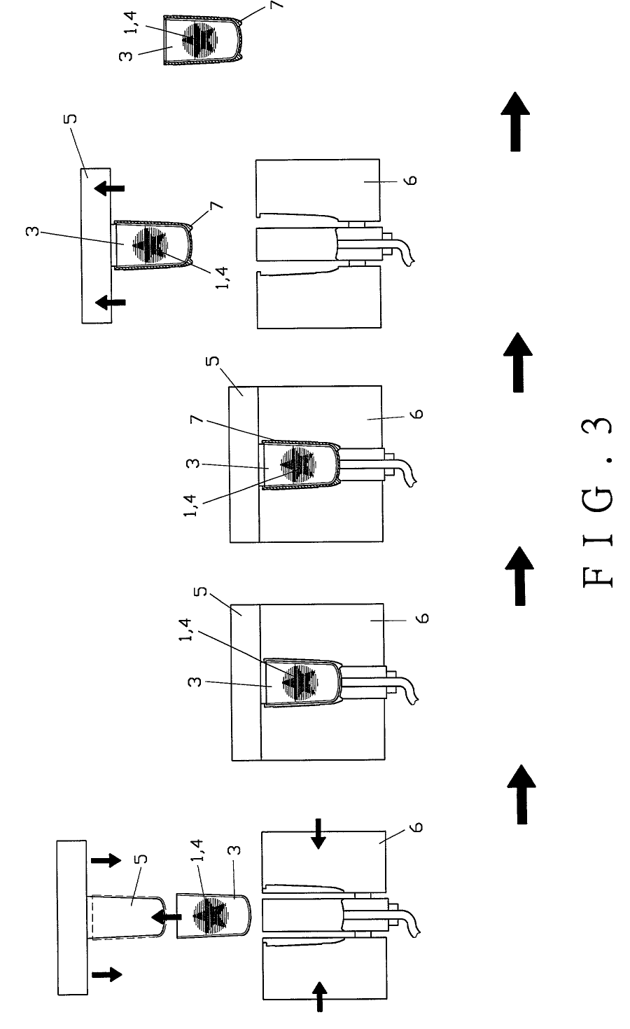

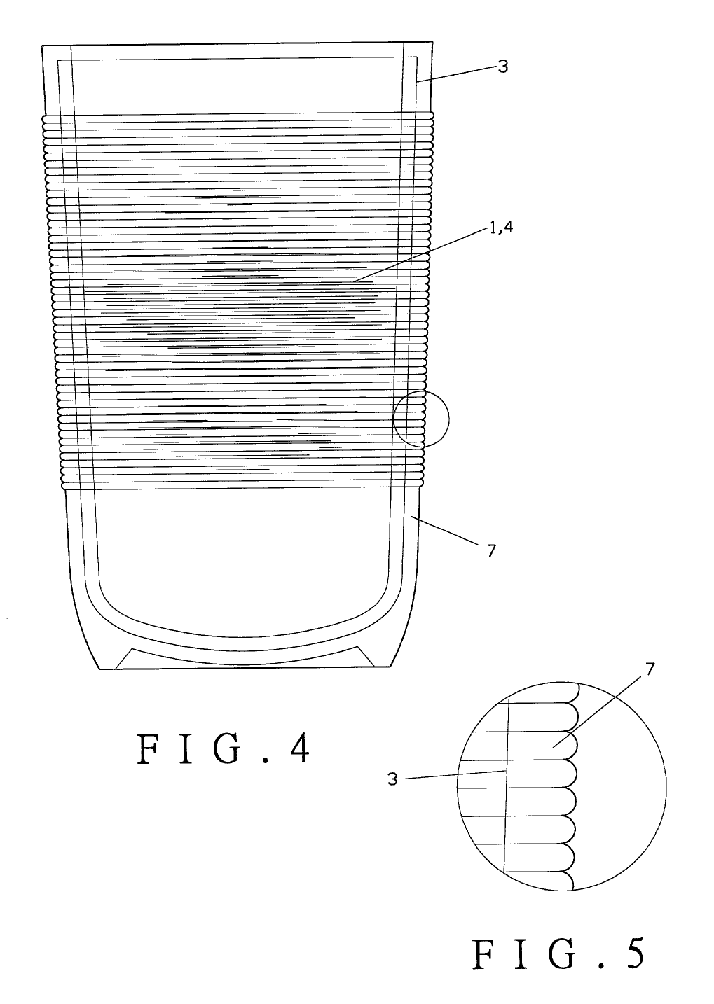

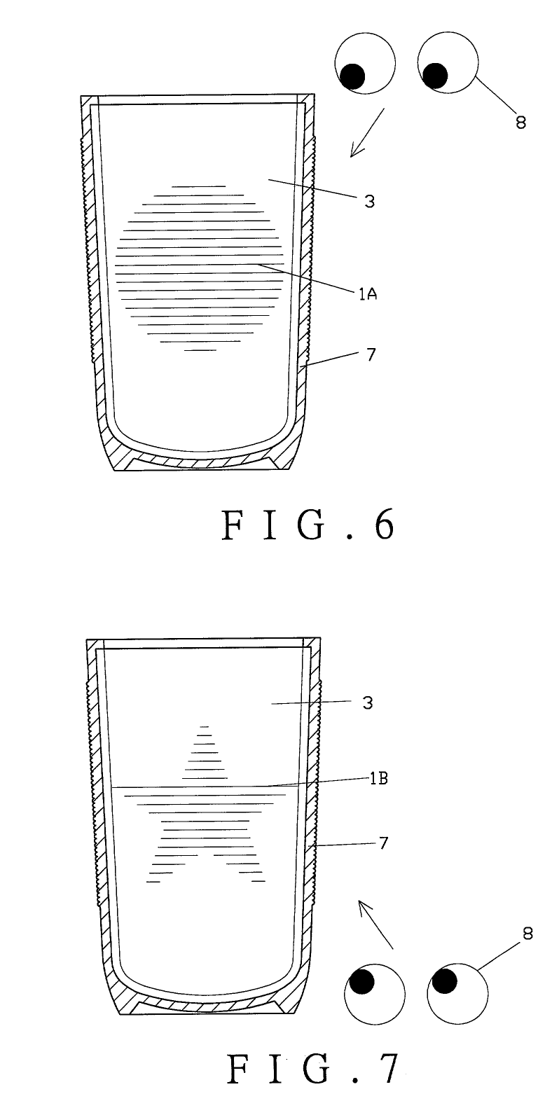

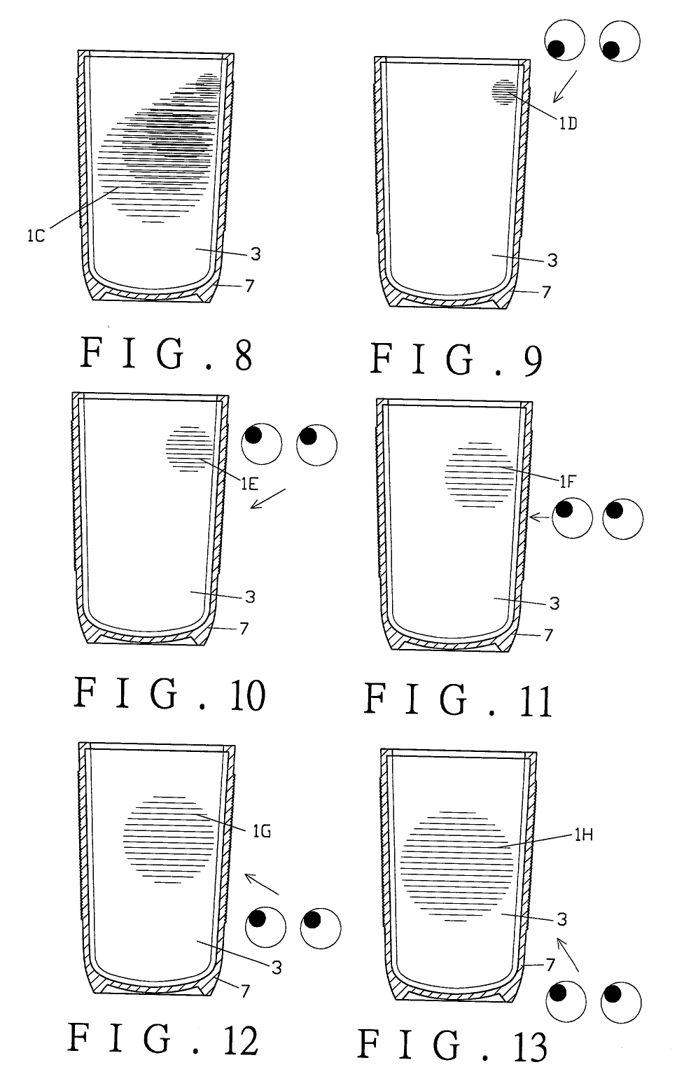

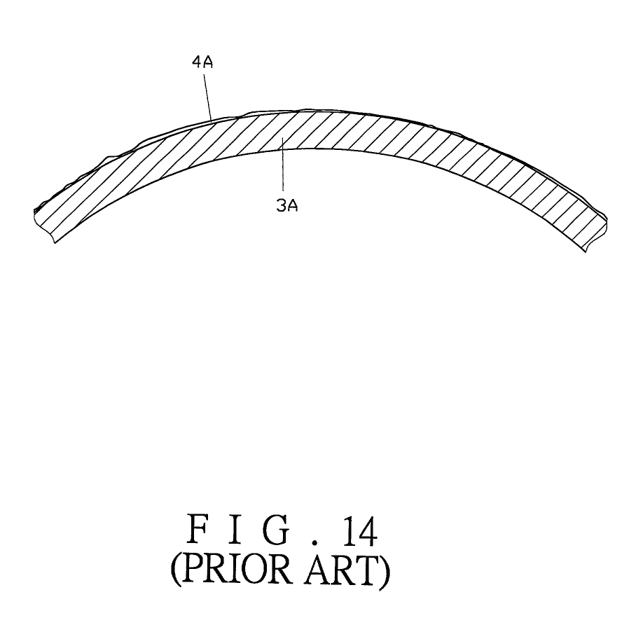

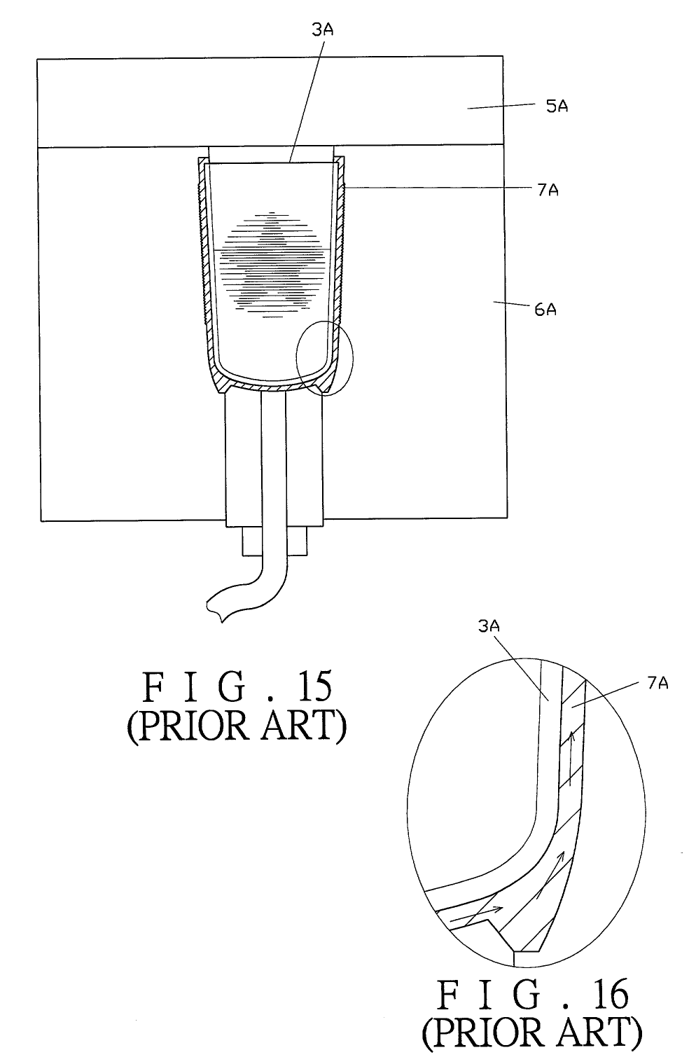

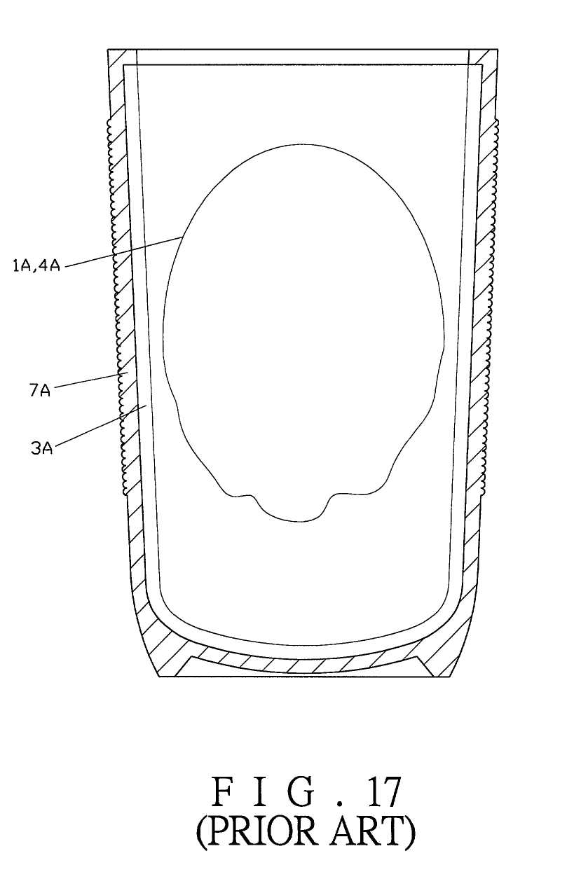

Referring to FIG. 1, a 3D-animation layer (1) is first transferred to an inner cup (3) using a thermal-withstanding silicon rubber roller (2), followed with a transfer of a thermal-withstanding protection layer (4) to the exterior of said 3D-animation layer (1) using the thermal-withstanding silicon rubber roller (2). As illustrated in FIG. 2, the surface of the inner cup (3) (already containing both of the 3D-animation layer (1) and the thermal-withstanding protection layer (4)) will be very flushed while the thermal-withstanding layer (4) will secure the 3D-animation layer in position. In FIG. 3, the inner cup (3) then is placed in an upper die (5) and locked up with a lower die (6) for injection molding a transparent outer cup (7) that encapsulates the inner cup. As illustrated in FIGS. 4 and 5, layer by layer in clean cut sequence, the thermal-withstanding layer (4), the 3D-animation layer (1), and the inner cup (3) are encapsulated by the transparent outer cup (7) while pattern on the 3D-animation layer (1) is clear and natural. In a preferred embodiment of the present invention as shown in FIGS. 6 and 7, a finished product when looked at by a viewer (8) at different locations, said 3D-animation (1A)(1B) caught between the inner cup (3) and the transparent outer cup (7) also varies. Furthermore, as illustrated in FIGS. 8 through 13, a finished product using another preferred embodiment of the present invention allows versatile changes by the 3D-animation (1C)(1D)(1E)(1F)(1G)(1H) depending on the angle of the viewer (8).

I claim:

1. An injection encapsulating process for a 3D-animation cup, wherein, a layer of 3D-animation first transferred to an inner cup, followed by a transfer of a thermal-withstanding protection layer to the exterior of said 3D-animation layer, then a transfer of both said 3D-animation layer and said thermal-withstanding protection layer to the surface of the inner cup, finally, the cup transferred with said 3D-animation layer and the thermal-withstanding protection layer placed in dies to be encapsulated and become an integrated part with an injection molded transparent outer cup.
